(19) United States
(12) Patent Application Publication
(10) Pub. No.: US 2011/0297610 A1
(43) Pub. Date: Dec. 8, 2011

(54) Polymers and Metallic Organic Framework Composites and Methods of Preparation Thereof

(76) Inventors: Rafael Auras, Lansing, MI (US); Susan Selke, East Lansing, MI (US); Dhayalan Elangovan, East Lansing, MI (US); Isinay E. Yuzay, East Lansing, MI (US)

(21) Appl. No.: 12/893,845

(22) Filed: Sep. 29, 2010

Related U.S. Application Data
(60) Provisional application No. 61/246,871, filed on Sep. 29, 2009.

(51) Int. Cl. B01D 15/04; B01D 39/16

(52) U.S. Cl. 210/435; 210/502.1

(57) ABSTRACT

A composite of polymer and metallic organic framework materials to form porous, multidimensional structures which is exposed to a contaminated fluid for promoting the sorption of contaminants thereto.

### CROSS-REFERENCE TO RELATED APPLICATION

The instant application claims priority to U.S. Provisional Patent Application Ser. No. 61/246,871, filed Sep. 29, 2009, the disclosure of which is expressly incorporated herein by reference.

### FIELD OF THE INVENTION

The invention is generally directed to substances used to promote high efficiency sorption.

### BACKGROUND OF THE INVENTION

Sorption technology for the removal of contaminants has many medical, environmental, commercial and industrial applications. For example, materials such as activated carbon, zeolite, alumina, or silica are often used to increase the sorptive capacity for certain liquids and gases. However, the relative sorptive capacity of these compounds is limited by the available surface area associated with each compound, and the surface area of these compounds can not be easily increased without negatively impacting features of the system in which they are employed, such as the overall size of the system. Thus, there is a continual demand for compounds, components and features that facilitate the high efficiency removal of contaminants in a variety of diverse applications without negative effects or changes to existing systems.

### SUMMARY OF THE INVENTION

In some embodiments, the invention is directed to a substance that may be used for the high efficiency removal of contaminants in a variety of applications, such as environmental, medical, commercial or industrial, which, among other things, provides a greater absorbent capacity for absorbing gases and liquids than compounds such as zeolite, alumina, active carbon or silica, without negative impacts or changes to existing systems. In some embodiments, the substance is a composite containing metallic organic framework (MOFs) materials, that is, crystalline compounds consisting of metal ions (e.g., copper, zinc, aluminum, etc.) or clusters thereof coordinated to form porous, multidimensional structures.

In some embodiments, the invention is directed to a composite substance comprising a polymer and metallic organic framework materials configured to form a porous, multidimensional structure for being exposed to a contaminated fluid to promote sorption of contaminants thereto. The metallic organic framework materials may be crystalline compounds including metal ions, such as those selected from the group consisting of copper, zinc or aluminum.

In some embodiments, the invention is directed to a device for removing fluid contaminants comprising a housing having a fluid entry port and a fluid exit port and a polymer composite material including a polymer and metallic organic framework materials mounted within the housing.

In some embodiments, the invention is directed to a composite of polymer and MOF, which is exposed to a fluid containing contaminants for the high efficiency removal, filtration, purification or separation thereof through sorption, among other things.

In some embodiments, the MOF contains poly(lactic acid), (PLA), but polyesters, polyolefins and other polymers in general may be employed with MOFs of the invention. In some embodiments, the invention is directed to a membrane, film or filter, which is configured with a polymer/MOF composite such as those described herein.

In some embodiments, the invention is directed to a substance employed in an active packaging system having a product storage compartment, wherein the substance modifies or affects one or more atmospheric conditions therein in order to enhance performance properties relating to the packaging system.

In some embodiments, the invention is directed to a substance for use in a packaging system which contains MOFs.

In some embodiments, the invention is directed to polymer-based, multifunctional membranes containing MOFs, as well as packaging systems or other applications which may employ MOFs to enhance performance properties and contaminant removal or otherwise prolong the degradation of a perishable item.

In some embodiments, the invention is directed to a polymer/MOF composite material which is employed in the construction, configuration, or retrofitting of a membrane, filter or packaging system, among other things, to enhance contaminant removal and performance properties, including the capacity for sorption of gases and liquids, such as organic vapors and water.

In some embodiments, the invention is directed to methods for preparing MOFs and membranes, filters or packaging systems, among other things, employing MOFs, including, but not limited to, MOFs containing PLA.

These and other aspects of the system and methods of the invention will become more readily apparent to those having ordinary skill in the art from the following description and figures.

### BRIEF DESCRIPTION OF THE FIGURES

FIGS. 1a and 1b are SEM images of exemplary MOF powders formed according to some embodiments of the invention, wherein FIG. 1a is taken at a magnification of 1000×, with a scale bar of 20 μm, and FIG. 1b is taken at a magnification of 3000×, with a scale bar of 10 μm;

FIG. 2a through 2i are SEM images of exemplary PLA and PLA composites with 5 wt % MOF fabricated using 2 and 5 min mixing time in the micro-compounder formed in accordance with some embodiments of the invention, wherein FIG. 2a is PLA at a magnification of 100×, with a scale bar of 200 μm, FIG. 2b is PLA at a magnification of 1000×, with a scale bar of 20 μm, FIG. 2c is PLA/MOF 5 wt %, 2 min mixing time at a magnification of 100×, with a scale bar of 200 μm, FIG. 2d is PLA/MOF 5 wt %, 2 min mixing time, at a magnification of 1000×, with a scale bar of 20 μm, FIG. 2e is PLA/MOF 5 wt %, 5 min mixing time, at a magnification of 100×, with a scale bar of 200 μm, FIG. 2f is PLA/MOF 5 wt %, 5 min mixing time, at a magnification of 1000×, with a scale bar of 20 μm, FIG. 2g is PLA/MOF 5 wt %, 5 min mixing time, at a magnification of 1600×, with a scale bar of 20 μm, FIG. 2h is PLA/MOF wt %, 5 min mixing time, at a magnification of 1600×, with a scale bar of 20 μm, and FIG. 2i is PLA/MOF 5 wt %, 5 min mixing time, at a magnification of 2500×, with a scale bar of 10 μm;

FIG. 3 is an exemplary graph of the IR Spectra of PLA and MOF samples between 1 and 5% wt. formed in accordance with some embodiments of the invention;

FIG. 4 is an exemplary graph of the visible and UV spectra of PLA and MOF samples formed in accordance with some embodiments of the invention;

FIG. 5 is an exemplary graph of the DMA curve for loss modulus, storage modulus and tan Δ for PLA+5% wt MOF formed in accordance with some embodiments of the invention;

FIG. 6 is a bar graph illustrating the impact strength analysis in J/m results of PLA/MOF composites formed in accordance with some embodiments of the invention, wherein different letters are significantly different at α=0.05;

FIG. 7 is an exemplary graph illustrating the sorption of PLA/MOF composites formed in accordance with some embodiments of the invention at 23° C. and 40% RH, wherein different letters may be significantly different at α=0.05 when calculated at a steady state of sorption; and

FIG. 8 is a schematic diagram illustrating an exemplary embodiment of the invention employed in a contaminant removal device.

### DETAILED DESCRIPTION OF THE INVENTION

The advantages of substances and packaging systems employed and constructed in accordance with the invention will become more readily apparent to those having ordinary skill in the art from the following detailed description.

Exemplary embodiments of the invention which overcome known limitations and provide unpredicted improvements in the art may include MOFs. In one exemplary embodiment, MOFs are crystalline compounds consisting of metal ions or clusters coordinated to often rigid organic molecules to form one-, two-, or three-dimensional structures that can be porous. MOFs have a surface area of around 3000 m²/g or more. This surface area is close to one order of magnitude higher than that of zeolite or activated carbon. In addition to the increased surface area, exemplary MOFs of the invention have open internal structures and long-range crystallinity, thus presenting pore sizes which can accommodate many different types of gases, such as carbon dioxide, oxygen, nitrogen and methane, as well as other volatile organic compounds (VOCs).

In some exemplary embodiments, poly(LD-lactic acid) (PLDLA), is compounded with MOF in order to produce a polymer membrane with the advantageous performance enhancing properties described herein. The composite material was found to have improved toughness and elongation at break when compared to the PLA polymer. The absorbent capacity of the composite material was found to be approximately twice that of the PLA polymer itself. While not wishing to be limited to any one theory, in this exemplary embodiment, it is presumed that the increased absorbent capacity is due to the increased surface area facilitated by the MOFs. In some embodiments, a polymer/MOF composite material may be fabricated through extrusion followed by injection molding.

Polymer/MOF composites such as those described herein are envisioned to have many varied uses throughout a wide range of industries. For example, polymer/MOF composites of the invention may be employed in active packaging systems. Active packages have features or components which modify or otherwise affect atmospheric conditions within the package headspace to improve the shelf-life, quality or integrity of the product contained therein. With regard to comestible products, active packages may be designed to include polymer/MOF composites which can beneficially modify or affect various atmospheric conditions that impact physiological processes (e.g., respiration of fresh fruits and vegetables), chemical processes (e.g., lipid oxidation), physical processes (e.g., staling of bread, dehydration), microbiological aspects (e.g., spoilage by micro-organisms) or infestation (e.g., by insects), for example.

The use of active packages with polymer/MOF composite can provide substantial savings to any companies involved in the procurement, transport or sale of perishable products. These savings may then be passed on to the consumer in the form of lower prices for such products.

Thus, in some exemplary embodiments, an active packaging system includes a polymer/MOF composite material, such as the materials described herein, and defines a compartment for storing a product therein.

In some embodiments, a polymer/MOF composite material constructed according to some embodiments of the invention can be applied to a packaging system as a coating. In other embodiments, the composite material may be added to a product storage compartment as a separate substrate or packing agent. In yet other embodiments, the packaging system may be formed in whole or part of a composite material such as the material described herein.

The active packaging system may include other atmospheric modifying features, such as one or more temperature excursion and/or oxygen sensor(s), tamper detection seals, disinfectants, or desiccants.

In other embodiments, the polymer/MOF composite material may be employed as a membrane for contaminant removal, such as in a separation, filtration and/or purification process. The polymer/MOF composite of the invention may be used in a variety of medical procedures, such as suturing, blood and plasma purification, and disease treatment, as well as in environmental remediation, such as wastewater or groundwater treatment, air pollution control and hazardous waste management.

It should be readily apparent to one skilled in the art that it is within the purview of the invention to incorporate, configure or otherwise utilize polymer/MOF composites of the invention in any form, which would be well-suited for the particular application. For example, polymer/MOF composites of the invention may be provided in membrane, filter or additive forms.

The following description provides an exemplary method of preparation of polymer/MOF composites of some embodiments of the invention.

In this example, poly(L-lactic acid) (94% L-lactide) resin samples (4042D) were obtained from Nature Works LLC (Blair, Nebr.) and the Metal Organic Framework samples were obtained from Sigma Aldrich (St Louis, USA) under the trade name of Basolite C-300 (copper benzene1,3,5-tricarboxylate; surface area between 1500 and 2000 m²/g). PLA resin pellets were dry mixed with MOF powders in various ratios and then the mixture was fed into a micro-compounding machine (DSM Research, The Netherlands) equipped with corotating twin screws having lengths of 150 mm, L/D ratio of 18, and capacity of 15 cc. After a certain cycle time, the PLA/MOF extrudates were transferred into the injection molder by a pre-heated transfer cylinder. Various kinds of specimens, such as tensile, Izod and DMA bars were prepared using the injection molder.

The process conditions were optimized to enable production of high quality composite samples. For this example, the optimized process conditions for the extruder and injection molder are given in Table 1.

TABLE 1
Optimized Parameters of DSM Micro Extruder

| | | Injection |
|---|---|---|
| Variables | Extruder | Molder |
| Temperature (° C.) Top | 190 | |
| Temperature (° C.) Middle | 190 | |
| Temperature (° C.) Bottom | 190 | |
| Screw Speed (rpm) | 100 | |
| Cycle time (min) | 2, 5 | |
| Melt Temperature (° C.) | 185 | |
| Transfer Cylinder | | 195 |
| Temperature (° C.) | | |
| Pressure (psi) | | 150 |
| Mold Temperature (° C.) | | 30 |
| Residence Time (sec) | | 20 |

A compression molding machine (Model-M, Carver Laboratory Press, USA) was used to prepare films from the samples. These films were prepared for barrier properties measurements. The films were compressed between two hot platens in a press at about 165° C. and a compression load of about 5000 lbs for about 5 to 6 minutes.

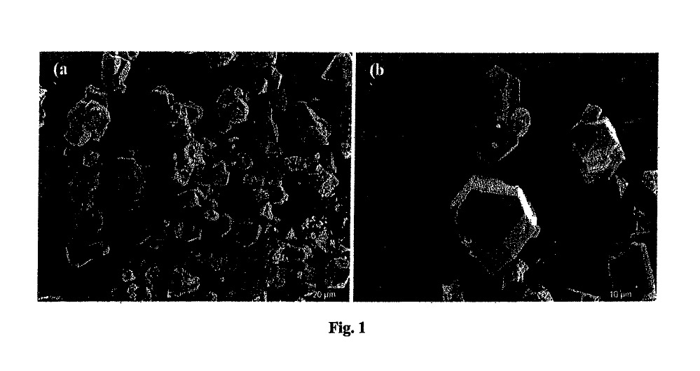

The morphology of MOF powders and impact fracture surfaces of PLA and PLA/MOF composites were observed using a JOEL JSM-6400 (Joel Ltd., Tokyo, Japan) scanning electron microscope equipped with a LaB₆ gun. Before collecting the micrographs, the powders and fractured surfaces of the composites were coated with a thin layer of gold using an Emscope SC500 sputter coater (Emscope Laboratories Ltd, Ashford, UK). The micrographs collected were the secondary electron images obtained with a beam energy of 15 kV. FIG. 1a,b shows the geometry of MOF powders, which are irregular polyhedron in shape and range from about 5 to about 20 μm in size.

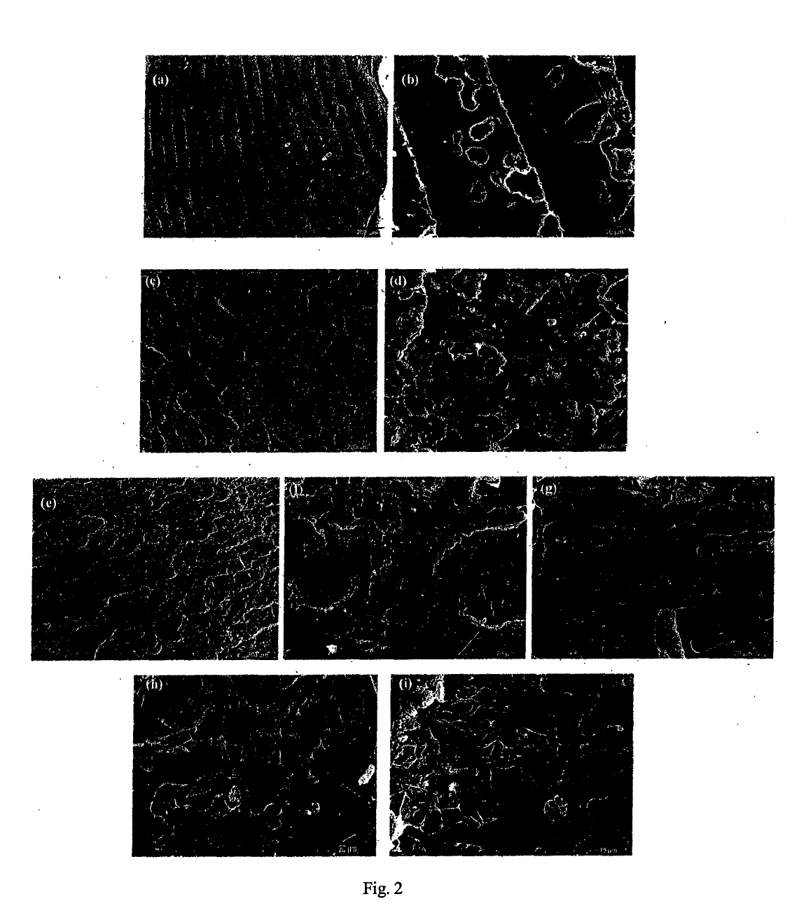

FIG. 2a-i display the SEM images of PLA and PLA/MOF composites. As can be seen in FIG. 2a the PLA specimen exhibited a typical brittle fracture and the fracture surface appeared to be very smooth. After inclusion of MOF powders, the brittle fracture surface of neat PLA became characteristic of a ductile fracture (FIG. 2c-i).

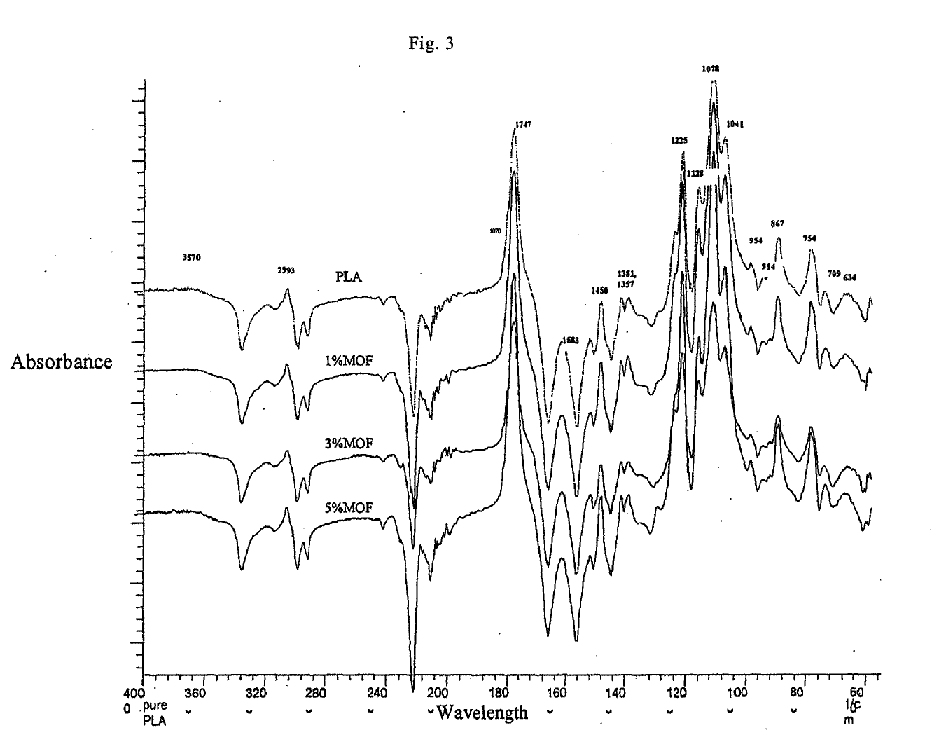

The composite samples produced using 2 min mixing time in the mini-extruder exhibited a non-uniform distribution of MOF powders. The MOF powders tend to agglomerate in the PLA matrix (FIG. 2c-d). A better dispersion of MOF powders within the PLA was observed when a mixing time of 5 min was used (FIG. 2e-i). The images taken at high magnification levels revealed void formation at the interface of the PLA matrix and the MOF powders (FIG. 3h-i). It is believed that the formation of voids may be the result of poor interfacial adhesion between the PLA matrix and the MOF powders, among other things.

The optical properties were observed using Fourier Transform Infrared Spectroscopy (FTIR). The IR spectroscopic analysis of pure PLA and PLA with 1, 3, and 5 wt % of MOF was performed using a Shimadzu IR Prestige-21 IR spectrometer. A background scan was done between the wavenumbers 4000-550 cm⁻¹ by keeping the resolution as 4 and the number of scans to 40. After the background scan, film samples were placed in the sample holder and scanned at the same rate as the background scan. The IR spectra of the film samples are shown in FIG. 3. No particular IR absorption peak distinguishing the MOF was observed. The peak assignments are shown in Table 2.

TABLE 2
FTIR absorption bands of PLA and MOF

| Wavenumber | |
|---|---|
| cm⁻¹ | Assignment |
| 3570 | —OH Stretch(free) |
| 2993 | —CH Stretch |
| 1747 | —C=0- Carbonyl stretch |
| 1450 | —CH3 bend |
| 1381, 1357 | —CH— Sym,, Asym. bend |
| 1225 | —C═O bend |
| 1128, 1078 | —C-0- Stretch |
| 1041 | —OH bend |
| 954 | —CH3 rocking |
| 914, 867 | —C—C— stretch |

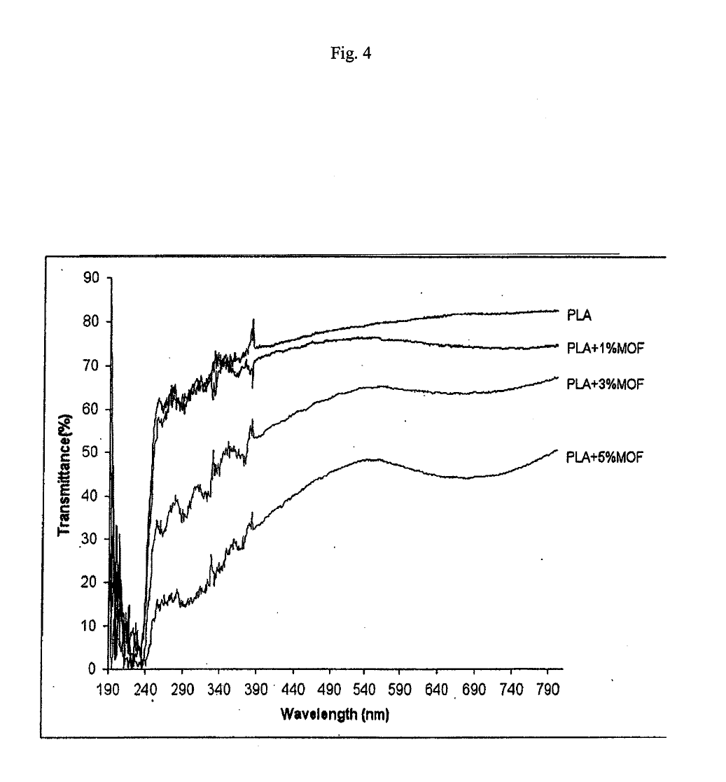

An ultraviolet/visible spectroscopic analysis of the film samples was performed using a UV/Visible spectrometer (Perkin-Elmer Lambda). A PLA blank was first placed in the UV/VIS spectrometer and scanned in the range of 190 to 800 nm. After scanning of the PLA blank, the film samples were placed and scanned in the same range as was used for the blank. The UV/Visible spectrum of the film samples shown in FIG. 4 gives a distinct absorbance and transmittance peak in the 190 to 800 nm range (UV and visible range). The MOF (Basolite C300) is cyan (blue+green) in color due to the presence of copper (Cu) ions in the matrix. The cyan color showed an increased absorbance in the red region (620 nm-750 nm) as the amount of MOF increased. It is also evident from the spectrum that as the percentage of MOF increases, the transmittance in the UV region decreases.

The color of the film samples was analyzed using a Colorimeter (Labscan XE, Hunter Laboratories). The CIE L*a*b* system was used to characterize the color of the samples. The L*, a*, b* and AE values of the film samples are given in Table 3.

TABLE 3
CIE L*a*b* Values of for PLA and MOF sam les

| Material | L* | a* | b* | AE |
|---|---|---|---|---|
| PLA | 92.5 ± 0.1^{a} | −1.1 ± 0.01^{a} | 0.9 ± 0.03^{a} | N/A |
| PLA + 1% MOF | 87.8 ± 1.2^{b} | −3.70.5^{b} | 2.3 ± 0.4^{b} | 5.5^{a} |
| PLA + 3% MOF | 81.7 ± 1.7^{c} | −7.2 ± 0.7^{c} | 2.4 ± 0.1^{b} | 12.5^{b} |
| PLA + 5% MOF | 76.8 ± 1.3^{d} | −9.1 ± 0.6^{d} | 2.2 ± 0.2^{b} | 17.67^{c} |

Note:
Values in the same column with different superscript letters are significantly different at α = 0.05

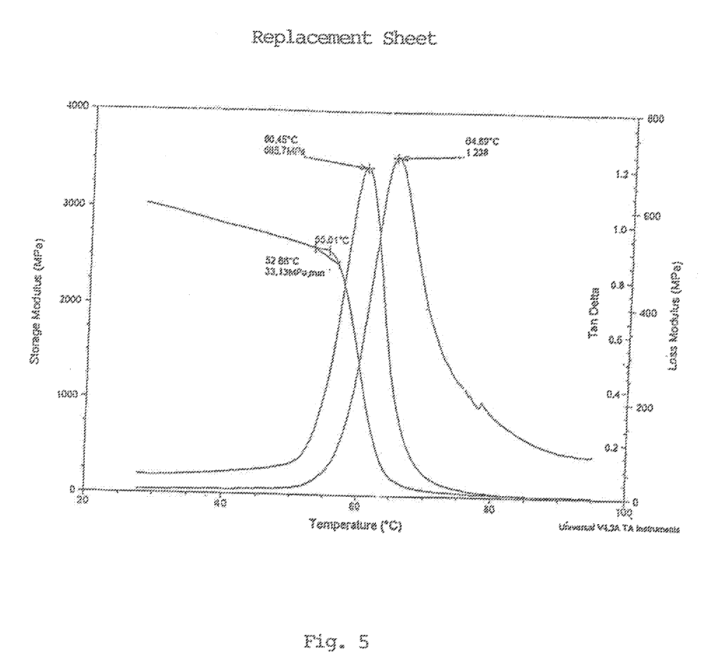

A dynamic mechanical analyzer (DMA Q800—TA instruments, USA) was used to measure the heat deflection temperature (HDT) and glass transition temperature (T_{g}) measuring the loss modulus, storage modulus and tan delta. The HDT was measured according to ASTM D5023 using the three point bending mode. HDT was measured at 0.2% percent of strain while heating from room temperature to 100° C. under a constant load. The T_{g} was measured according to the ASTM D4065 standard using the dual cantilever mode at an amplitude of 15 um and frequency of 1 Hz. Table 4 depicts the HDT and the T_{g} obtained by tan delta. FIG. 5 shows a graph of the DMA testing for the Loss Modulus, Storage Modulus and Tan Δ for PLA+5 wt % MOF.

TABLE 4
Heat Deflection Temperature of the samples

| Material | HDT (° C.) | T_{g} by Tan Δ |
|---|---|---|
| PLA | 53.4 ± 0.7^{a} | 65.4 ± 0.2^{a} |
| PLA + 1% MOF | 54.1 ± 0.3^{a} | 65.2 ± 0.3^{a} |
| PLA + 3% MOF | 54.6 ± 0.4^{a} | 65.0 ± 0.3^{a} |
| PLA + 5% MOF | 54.7 ± 0.2^{a} | 64.7 ± 0.1^{a} |

Note:
Values in the same column with different superscript letters are significantly different at α = 0.05

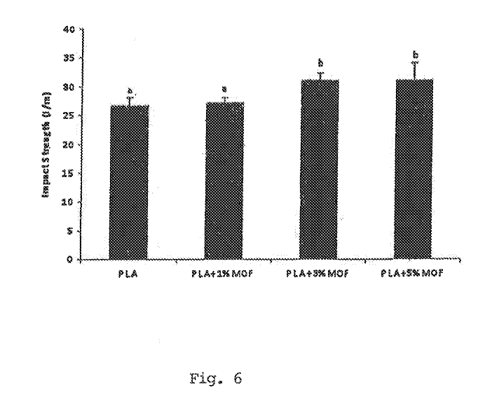

The impact strength of the samples was measured using the Monitor Izod Impact tester (Testing Machines Inc. USA, Model TMI 43-02-01) with 1-lb pendulum to measure the notched Izod impact strength of samples at ambient conditions according to the ASTM D256 standard. A TMI notching cutter (model 22-05) was used to notch the samples as required by the standard. The impact strength of the PLA/MOF composite samples is shown in FIG. 6. As the amount of MOF increased to higher than 3% by wt, the impact strength of the composites increased by more than 5%.

The thermal properties of PLA/MOF composites and films were studied by using differential scanning calorimetry (DSC). A heat-cool-heat cycle was used to measure the T_{g}, T_{c}, and Tₘ of the samples. Samples on the order of 7 to 10 mg were weighed and hermetically sealed in an aluminum pan. After placing the sample and reference in the DSC cell, the cell was heated from 0 to 200° C. at 10° C./min. After the completion of the first heating cycle, the cell was cooled down from 200 to 0° C. at 10° C./min, and for the second heating cycle the same ramping conditions were used as that of the first heating cycle. Table 5 summarizes the thermal properties of the PLA/MOF composites determined by DSC. In the case of films, we can observe that MOFs are acting as nucleating agents.

TABLE 5
Thermal Properties of PLA/MOF Composites

| MOF | | | | | |
|---|---|---|---|---|---|
| con- | | | | ΔH_{crystal} | ΔH_{crystal} |
| tent | T_{g} (° C.) | T_{c} (° C.) | Tₘ (° C.) | (J/g) | (J/g) |
| 0 | 61.0 ± 0.2a | 130.7 ± 0.3a | 152.1 ± 0.1a | 7.1 ± 0.3a | 7.9 ± 0.4a |
| 1 | 61.1 ± 0.2a | 131.0 ± 0.2a | 152.3 ± 0.4a | 5.2 ± 0.5b | 5.9 ± 0.4b |
| 3 | 61.5 ± 0.1a | 131.4 ± 0.2a | 152.3 ± 0.4a | 4.2 ± 0.2c | 5.2 ± 0.2b |
| 5 | 61.3 ± 0.2a | 131.6 ± 0.1a | 152.4 ± 0.4a | 3.8 ± 0.2c | 4.6 ± 0.2b |

Note:
Values are represented as averages ± standard deviation. Values with different letters in the same column is significantly different at α = 0.05 (Tukey − HSD)

TABLE 6
Thermal properties of PLA/MOF films

| MOF | | | | | | | |
|---|---|---|---|---|---|---|---|
| content | T_{g} (° C.) | T_{c} (° C.) | Tₘ₁ (° C) | Tₘ₂ (° C.) | H_{c} (J/g) | Hₘ (J/g) | X_{c}(%) |
| 0 | 60.1 ± 0.1a | 129.2 ± 0.2a | 151.3 ± 0.3 | | 12.5 ± 0.4a | 13.9 ± 0.2a | 1.5 ± 0.2a |
| 1 | 59.8 ± 0.2a | 123.2 ± 0.7b | 149.6 ± 0.0a | 154.9 ± 0.2a | 23.9 ± 2.2b | 25.6 ± 2.3b | 1.8 ± 0.9a |
| 3 | 59.2 ± 0.1a | 117.1 ± 0.1c | 148.1 ± 0.1a | 155.2 ± 0.1a | 32.9 ± 0.6c | 34.7 ± 0.7c | 1.9 ± 0.5a |
| 5 | 59.2 ± 0.2a | 115.0 ± 0.8d | 147.3 ± 0.2a | 154.9 ± 0.1a | 33.5 ± 0.7c | 34.9 ± 1.2c | 1.7 ± 1.1a |

Note:
Values are represented as averages ± standard deviation. Values with different letters in the same column is significantly different at α = 0.05 (Tukey − HSD). Tₘ₁ and Tₘ₂ are the first and second melting temperature observed in PLA/MOF films.

The mechanical properties of the samples were measured according to the ASTM D638 standards using a universal testing machine (UTS). The samples were conditioned for 24 hours at 23° C. and 50% RH before testing. A 1000 lb load cell was used to test the samples. Table 7 shows the mechanical properties of the PLA/MOF composites. Strain at break of the samples containing more than 1% wt of MOF increased by 170 times.

TABLE 7
Mechanical Properties of PLA/MOF Composites

| MOF | Tensile | Modulus of | Strain at | Strain at |
|---|---|---|---|---|
| Content | Strength | Elasticity | yield | break |
| Wt. % | (kpsi) | (kpsi) | (%) | (%) |
| 0 | 9.3 ± 0.26^{a} | 479.53 ± 1^{a} | 2.45 ± 0.2^{a} | 1.17 ± 0.3^{a} |
| 1 | 8.69 ± 0.19^{b} | 488.16 ± 30.7^{a} | 2.46 ± 0.2^{a} | 201.63 ± 2.4^{b} |
| 3 | 8.47 ± 0.36^{c} | 468.32 ± 41.6^{a} | 2.68 ± 0.2^{a} | 192.69 ± 9.7^{b} |
| 5 | 6.95 ± 0.19^{d} | 490.39 ± 32.3^{a} | 2.28 ± 0.2^{a} | 193.32 ± 8.6^{b} |

Note:
Values in the same column with different superscript letters are significantly different at α = 0.05

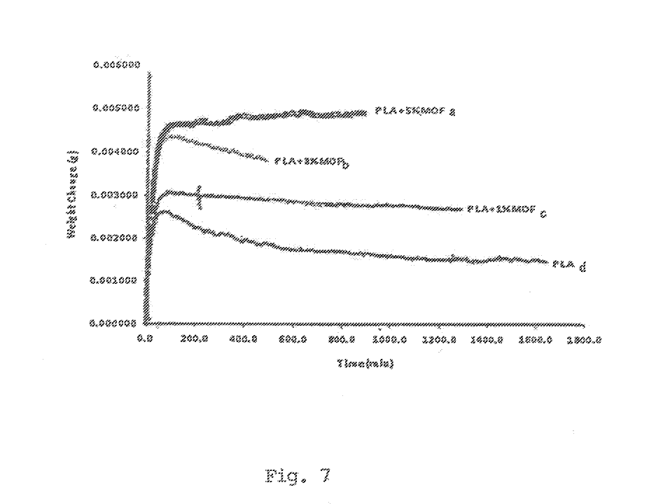

The moisture sorption of PLA/MOF samples was examined by gravimetric analysis using an SGA-100 from VTI Corporation (Florida, US). The PLA/MOF composite film samples with weights of 4 to 5 mg were exposed to 40% RH at 23° C. and the weight gain of the samples was recorded. The moisture gain as a function of time is shown in FIG. 7. As the wt % MOF increased the sorption of water increased.

The barrier properties of the films were measured using the film samples that were produced through the compression molding machine as shown in Table 8. The water vapor transmission rate (WVTR) was determined using a Permatran W3/31 (MOCON Inc.). The conditions used for the experiment were as follows: area of the film 3.14 cm²; RH: 100%; carrier gas N2; temperature 23° C. The oxygen transmission rate (O₂TR) was determined with an Oxtran 100 Twin (MOCON Inc.). The conditions used for the experiment were as follows: area of the film 3.14 cm²; permeant 0.21 atm of O₂; carrier gas, N₂ containing 2% H₂; temperature 23° C.; and 0% relative humidity. No differences between the PLA and the PLA samples containing MOF were found.

TABLE 8
Barrier properties of PLA/MOF Composites

| | O₂ Permeability | H₂O Permeability |
|---|---|---|
| | kg · m/m² · | kg · m/m² · |
| Material ID | s · kPa × 10⁻¹³ | s · kPa × 10⁻¹¹ |
| PLA | 4.9 ± 0.5^{a} | 3.1 ± 0.5^{a} |
| PLA + 1% MOF | 4.3 ± 0.2^{a} | 2.5 ± 0.5^{a} |
| PLA + 3% MOF | 4.0 ± 0.3^{a} | 2.5 ± 0.01^{a} |
| PLA + 5% MOF | 4.8 ± 0.7^{a} | 2.5 ± 0.5^{a} |

Note:
Values in the same column with different superscript letters are significantly different at α = 0.05

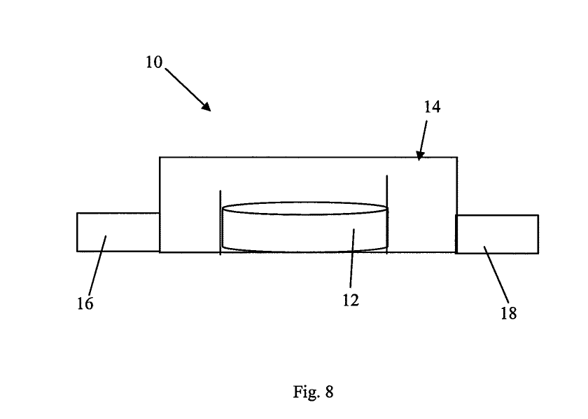

As shown in FIG. 8, a device generally referred to by the reference numeral 10 employs a composite structure 12 constructed according to the invention, such as described in the exemplary embodiments discussed above. Device 10 includes a housing 14 for supporting composite structure 12 therein. Fluid enters housing 14 via a fluid entry port 16. Composite structure 12 is supported within housing 14 to contact fluid entering port 16. Device 10 may be constructed to cause fluid contact with composite structure 12 according to various parameters, such as a desired duration. It should be readily apparent that additional structures such as structure 12 may be provided in various shapes and sizes within housing 14. Structure 12 may also be a configured as a film of material disposed on an interior wall or included in a filtration membrane which the fluid passes through. It is envisioned that fluid entering port 16 may include contaminants which could be removed via sorption with composite structure 12, and treated fluid exits housing 14 through fluid exit port 18.

Although exemplary embodiments of the invention and forming methods have been described herein, it is to be understood that the disclosed substances, applications, systems and methods of use and manufacture may be practiced successfully without the incorporation of each of those features. The foregoing described embodiments are provided as illustrations, and they are not intended to limit the invention to the precise forms described herein. In particular, it is contemplated that functional implementation of the invention described herein may be constructed of varying polymer/MOF composites, sizes and forms, Thus, variations and further embodiments are possible in light of above teachings, and it is not intended that this description should limit the scope of invention. It is to be understood that modifications and variations may be utilized without departure from the spirit and scope of the invention and method disclosed herein, as those skilled in the art will readily understand. Such modifications and variations are considered to be within the purview and scope of the invention described herein and recited in the claims, including exemplary methods of preparation of polymer/MOF composites.

What is claimed is:

1. A composite substance comprising a polymer and metallic organic framework materials configured to form a porous, multidimensional structure for being exposed to a contaminated fluid to promote sorption of contaminants thereto.

2. A composite substance as recited in claim 1, wherein the polymer is PLA.

3. A composite substance as recited in claim 1, wherein the metallic organic framework materials are crystalline compounds including metal ions.

4. A composite substance as recited in claim 3, wherein the metal ions are selected from the group consisting of copper, zinc or aluminum.

5. A device for removing fluid contaminants comprising
a. a housing having a fluid entry port and a fluid exit port; and
b. a polymer composite material including a polymer and metallic organic framework materials mounted within the housing.

6. A device as recited in claim 5, wherein the polymer in the composite is PLA.

7. A device as recited in claim 5, wherein the metallic organic framework materials include crystalline compounds having metal ions.

8. A device as recited in claim 7, wherein the metal ions are selected from the group consisting of copper, zinc or aluminum.
